(19) United States
(12) Patent Application Publication
(10) Pub. No.: US 2026/0153194 A1
(43) Pub. Date: Jun. 4, 2026

(54) Boss for Hydrogen Tank

(71) Applicants: Hyundai Motor Company, Seoul (KR); Kia Corporation, Seoul (KR); LOTTE CHEMICAL CORPORATION, Seoul (KR)

(72) Inventors: Dong Sun Lee, Hwaseong-Si (KR); Gwi Nam Song, Hwaseong-Si (KR); Jong Ik Byun, Uiwang-Si (KR); Min Hyeok Hwang, Uiwang-Si (KR); Young Koan Ko, Uiwang-Si (KR); In Bo Kang, Uiwang-Si (KR)

(21) Appl. No.: 19/230,775

(22) Filed: Jun. 6, 2025

(30) Foreign Application Priority Data
Dec. 3, 2024 (KR) 10-2024-01778

(51) Int. Cl. F17C 13/00

(52) U.S. Cl. CPC F17C 13/002; F17C 2201/0109; F17C 2203/0604; F17C 2205/0305; F17C 2221/012; F17C 2260/036

(57) ABSTRACT

The present disclosure provides a boss for a hydrogen tank. The boss may include a nozzle boss and a fastener. The nozzle boss may include: a neck extending by a predetermined length; and a flange provided at a bottom portion of the neck. A chamber may be formed inside the neck. The flange may be integrated with the neck and configured to be joined to a liner of the hydrogen tank. The fastener may be installed at a lower region of the flange and in contact with a seam between the nozzle boss and the liner, to prevent a leak of a fluid through the seam.

### CROSS-REFERENCE TO RELATED APPLICATION

This application claims priority to and the benefit of Korean Patent Application No. 10-2024-0177778, filed in the Korean Intellectual Property Office on Dec. 3, 2024, the entire contents of which are incorporated herein by reference.

### TECHNICAL FIELD

The present disclosure relates to fuel cell vehicles, and more specifically to a hydrogen tank in a fuel cell system.

### BACKGROUND

Natural gas vehicles or hydrogen fuel cell vehicles are equipped with pressure vessels that store compressed gaseous fuel at high pressure.

The pressure vessel may include a liner made of plastic to reduce weight, a thermosetting fiber composite configured to surround an outer sheath of the liner, and a metallic boss.

Light-weight materials that can reduce the overall weight of the liner may include plastic materials such as polyolefin-based resins and polyamide-based resins. A composite material layer may be manufactured by mixing carbon fibers or glass fibers with polymer resin, such as epoxy resin, in order to maintain strength, and the composite material layer may be coupled to surround a surface of the liner. The boss may have a nozzle shape and be made of a metallic material to be securely coupled to a regulator or valve (hereinafter, collectively referred to as “valve”) made of a metallic material.

On such a pressure vessel, an inlet and/or an outlet may be formed, through which gaseous fuel consisting of hydrogen and the like may be introduced or discharged, and the metallic boss may be inserted into the inlet. However, a problem may arise in terms of the connection between the plastic liner and the metallic boss because of the disparate materials that the two components are made of. In addition, after multiple iterations of refueling of the vehicle, material fatigue may accumulate, increasing the risk of a leak of the stored gas.

Therefore, a high-strength metal material may be required for the boss, which regulates a gas flow, in order to prevent a gas leak between the plastic liner and the metallic boss. In this case, the connection at the interface between the plastic liner and the metallic boss may determine the performance of the product. In at least some implementations, only a simple coupling structure may be applied at the interface between the plastic liner and the metallic boss, thereby increasing the risk of a leak at the seams during long-term charging/discharging processes.

### SUMMARY

The present disclosure has been made in an effort to provide a boss for a hydrogen tank, the boss being capable of implementing primary high-pressure sealing by using pressure applied by a stored fluid and implementing secondary sealing by generating constant pressure in a low-pressure region that may be formed by a leak of the fluid while the pressure is released, thereby ensuring a structure of the boss with excellent sealability.

According to one or more example embodiments of the present disclosure, a boss for a hydrogen tank may include a nozzle boss and a fastener. The nozzle boss may include: a neck extending by a predetermined length; and a flange provided at a bottom portion of the neck. A chamber may be formed inside the neck. The flange may be integrated with the neck and configured to be joined to a liner of the hydrogen tank. The fastener may be installed at a lower region of the flange and in contact with a seam between the nozzle boss and the liner, to prevent a leak of a fluid through the seam.

The flange, at the lower region, may taper off with a first cascading contour. An inner surface of the fastener may be installed to be in contact with an outer surface of the flange. The inner surface of the fastener may have a second cascading contour that matches the first cascading contour of the flange.

A first screw thread may be formed on a surface of a lowermost step of the first cascading contour of the flange. A second screw thread may be formed on a surface of a lowermost step of the second cascading contour of the fastener. The fastener may be screw-fastened to the flange via the first screw thread and the second screw thread.

The fastener may include: a nut corresponding to the lowermost step of the second cascading contour of the fastener; and an extension wall disposed on top of the nut and tapering off with the second cascading contour. The nut may have the surface on which the second screw thread is formed.

One or more gaskets may be provided on the extension wall to maintain a seal at the seam after the nut is screw-fastened to the flange.

The one or more gaskets may include: a first O-ring installed on an inner surface of the extension wall; and a second O-ring installed on an outer surface of the extension wall.

An inner ring may be installed, below the first O-ring, on the inner surface of the extension wall. An outer ring may be installed, below the second O-ring, on the outer surface of the extension wall.

The liner may include a rib that extends from an inner peripheral surface of the liner to the seam. The rib may come into contact with the second O-ring to maintain the seal at the seam.

A protrusion may be formed at an upper tip of the extension wall and may be inserted into the seam.

The one or more gaskets may further include a third O-ring installed between the protrusion and the seam.

According to one or more example embodiments of the present disclosure, a boss assembly may include a boss, a fastener, and a plurality of gaskets. The boss may include: a nozzle having a cylindrical shape; a flange radially extending out from a bottom portion of the nozzle to be joined, at a seam, to a liner of a gas storage tank; a first disc disposed below the flange, the first disc having a first diameter; a second disc disposed below the first disc, the second disc having a second diameter that is less than the first diameter; and a third disc disposed below the second disc, the third disc having a third diameter that is less than the second diameter. A first screw thread may be formed on an outer surface of the third disc. The nozzle may include a gas inlet to the gas storage tank. The fastener may be configured to be fastened against the boss and the liner to create a seal at the seam. The fastener may include a first ring having a first radial thickness. A second screw thread, which corresponds to the first screw thread, may be formed on an inner surface of the first ring. The fastener may further include a second ring having a second radial thickness that is less than the first radial thickness. The second ring may be disposed on top of the first ring. The fastener may further include a third ring having a third radial thickness that is less than the second radial thickness. The third ring may be disposed on top of the second ring. The plurality of gaskets may include: a first gasket wedged between the second disc and the second ring; a second gasket wedged between the second ring and the liner; and a third gasket wedged between the third ring and the seam. The nozzle, the flange, the first disc, the second disc, and the third disc of the boss may be integrated to each other. The first ring, the second ring, and the third ring of the fastener may be integrated to each other.

As described above, the boss for a hydrogen tank according to the present disclosure may implement the primary high-pressure sealing by using the pressure applied by the stored fluid and implement the secondary sealing by generating constant pressure in the low-pressure region that may be formed by a leak of the fluid while the pressure is released, thereby ensuring the structure of the boss with excellent sealability.

### BRIEF DESCRIPTION OF THE DRAWINGS

FIG. 1 is a top plan view illustrating a structure of a boss for a hydrogen tank according to the present disclosure.

FIG. 2 is an enlarged view illustrating a main part of the boss for a hydrogen tank according to the present disclosure.

### DETAILED DESCRIPTION

Hereinafter, a boss for a hydrogen tank according to one or more example embodiments of the present disclosure will be described in more detail with reference to the accompanying drawings.

However, the technical spirit of the present disclosure is not limited to the example embodiments described herein but may be implemented in various different forms. One or more of the constituent elements in the example embodiments may be selectively combined and substituted for use within the scope of the technical spirit of the present disclosure.

In addition, unless otherwise specifically and explicitly defined and stated, the terms (including technical and scientific terms) used in the example embodiments of the present disclosure may be construed as the meaning which may be commonly understood by the person with ordinary skill in the art to which the present disclosure pertains. The meanings of the commonly used terms such as the terms defined in dictionaries may be interpreted in consideration of the contextual meanings of the related technology.

In addition, the terms used in the example embodiments of the present disclosure are for explaining the example embodiments, not for limiting the present disclosure.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

In addition, the terms such as first, second, A, B, (a), and (b) may be used to describe constituent elements of the example embodiments of the present disclosure.

These terms are used only for the purpose of discriminating one constituent element from another constituent element, and the nature, the sequences, or the orders of the constituent elements are not limited by the terms.

Further, when one constituent element is described as being ‘connected,’ ‘coupled,’ or ‘attached’ to another constituent element, one constituent element may be connected, coupled, or attached directly to another constituent element or connected, coupled, or attached to another constituent element through still another constituent element interposed therebetween.

In addition, the expression “one constituent element is provided or disposed above (on) or below (under) another constituent element” includes not only a case in which the two constituent elements are in direct contact with each other, but also a case in which one or more other constituent elements are provided or disposed between the two constituent elements. The expression “above (on) or below (under)” may mean a downward direction as well as an upward direction based on one constituent element.

In at least some implementations, different methods are proposed to prevent a gas leak from the pressure vessel, such as forming a screw thread on the boss, tightening the boss, a physical bonding structure using an insertion member, and a chemical bonding structure using thermal fusion.

However, the structures in these implementations that physically couple the liner and the boss may have disadvantages, including a need for a complicated structure for the boss, an increased weight of the boss, an increased cost of manufacturing the boss, and an increased number of complex processes. In addition, the physical coupling structure in these implementations may have a problem of having a structure vulnerable to fatigue loads caused by repetitive processes such as a refueling process.

In addition, another problem is that the deterioration of the seal may require that the entire vessel, which may otherwise still have a remaining service life, be discarded when a gas leak occurs during a long-term use. This may cause a great economic loss. The present disclosure, through one or more example embodiments, will describe ways to alleviate or eliminate these problems.

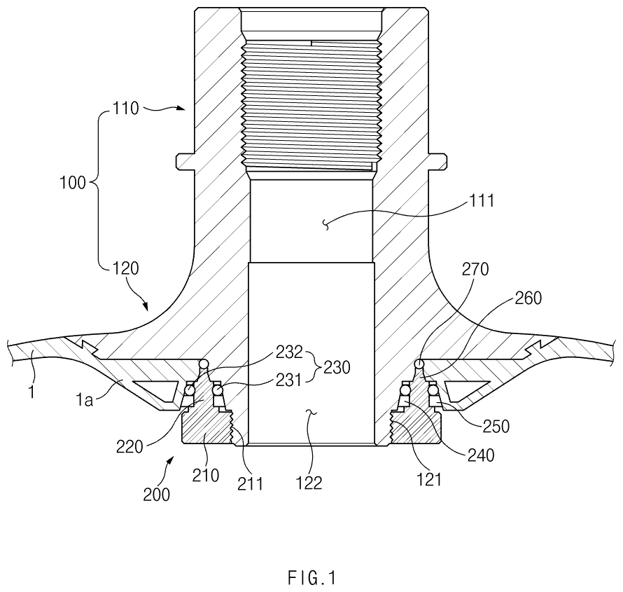

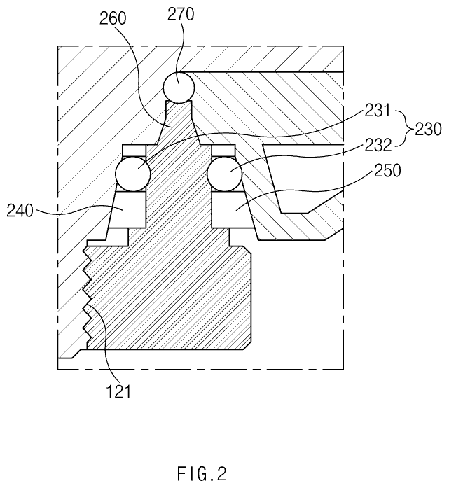

FIG. 1 is a top plan view illustrating a structure of a boss for a hydrogen tank, and FIG. 2 is an enlarged view illustrating a main part of the boss for a hydrogen tank.

As illustrated in these drawings, a boss for a hydrogen tank may include a nozzle boss 100. The nozzle boss 100 may include a neck (also referred to as a neck portion, a cylinder, or a nozzle) 110 and a flange (also referred to as a flange portion, a ridge, a lip, a rim, or a skirt) 120. A chamber (also referred to as a hollow portion, a cavity, a space, etc.) 111 may be formed inside the neck 110. The neck 110 may extend by a predetermined length. The flange 120 may be provided on the neck 110 (e.g., at a bottom portion of the neck 110). The flange 120 may be integrated with the neck 110. The flange 120 may radially extend out from the bottom portion of the neck 110. The flange 120 may be joined to a liner 1 by, for example, insert-injection molding. The liner 1 may have a charging space (e.g., storage space) capable of being charged (e.g., filled) with (e.g., storing) a fluid (e.g., hydrogen gas); and a fastener (also referred to as a sealing part, a seal, a hermetic seal, a gasket, or a stop) 200 installed in (e.g., around) an end (e.g., lower) region (e.g., a terminus, a tip, etc.) of the flange 120 and provided to be in contact with a boundary region (e.g., a seam) between the nozzle boss 100 and the liner 1. The fastener 200 may reduce or prevent the fluid from leaking at or through the boundary region between the nozzle boss 100 and the liner 1.

The neck 110 may protrude by a predetermined length from an inlet side of the liner 1, which may constitute the body of a hydrogen tank. The neck 110 may serve as an inlet, through which hydrogen may enter the interior of the hydrogen tank be stored therein. The neck 110 may have the chamber 111 inside the neck 110, and the chamber 111 may serve as a passageway through which the hydrogen tank may be filled with hydrogen.

The flange 120 may refer to a member provided at a lower (e.g., closer to the interior of the tank) side of the neck 110. The flange 120 may be integrated with the neck 110, and joined to the liner 1 so that the neck 110 is connected to the liner 1. A passage hole (also referred to as a communication hole) 122 may be formed through the flange 120 and connect to the chamber 111 formed in the neck 110.

The flange 120 and the liner 1 may be joined to each other by, for example, insert-injection molding (also referred to as insert molding). Insert-injection molding may be advantageous as it allows the hydrogen tank to be rapidly and easily manufactured. Further, the boundary region (e.g., seam) between the liner 1 and the flange 120 may be securely implemented by insert-injection molding, such that a leak from the boundary region may be reduced or prevented.

The end region of the flange 120 may be formed in a stepped shape (e.g., having a cascading contour) so that an outer diameter of the end region of the flange 120 decreases downward (e.g., tapers off). The end region of the flange 120 may have a cascading structure comprising a first disc, a second disc disposed below the first disc, and a third disc disposed below the second disc. The second disc may have a diameter smaller than that of the first disc. The third disc may have a diameter smaller than the second disc. An inner circular wall surface (also referred to as an inner diameter portion) of the fastener 200, which will be described below and is installed to be in contact with an outer circular wall surface (also referred to as an outer diameter portion) of the flange 120, may be formed in a stepped shape. The stepped (e.g., cascading) shape of the inner circular wall surface of the fastener 200 may mirror that of the outer circular wall surface of the fastener 200. The stepped (e.g., cascading) shape of the inner circular wall surface of the fastener 200 may correspond to the shape of the outer circular wall surface of the flange 120. In other words, the inner surface of the fastener may have a cascading contour that matches the cascading contour of the lower tip of the flange.

The boundary region (e.g., seam) at which the flange 120 and the fastener 200 are joined to each other may be formed in the stepped (e.g., cascading) shape, such that the contact area may be expanded, a leak from the boundary region may be reduced or prevented, and the boundary region may be securely sealed.

A screw thread (e.g., a helical ridge) 121 may be formed on an outer surface (e.g., an outer circular wall surface) of the flange 120 (e.g., on a surface of a lowermost step of the cascading contour of the flange 120). A screw thread 211 (e.g., a matching screw thread) may be formed on an inner surface (e.g., an inner circular wall surface) of the fastener 200 (e.g., at a lowermost portion of the inner surface of the fastener 200), such that the fastener 200 and the flange 120 may be screw-fastened and coupled to each other.

The fastener 200 may be configured to be fastened against the boss (e.g., the nozzle boss 100) and the liner 1 to create a seal at a seam (e.g., the boundary region). The fastener may have a cascading structure including a first ring, a second ring, and a third ring. The first ring may have a first radial thickness. A screw thread, which corresponds to the screw thread of the flange 120, may be formed on an inner surface of the first ring. The second ring may have a second radial thickness that is less than the first radial thickness. The second ring may be disposed on top of the first ring. The third ring may have a third radial thickness that is less than the second radial thickness. The third ring may be disposed on top of the second ring.

With the structure in which the boundary region (e.g., seam) is formed in the stepped shape and the fastener 200 is screw-fastened and coupled to an outer surface of an end of the flange 120, a plurality of points on the flange 120 may be pressed (e.g., compressed) toward the liner 1 only by the shape of the fastener 200 in the boundary region. As a result, the boundary region may be pressed (e.g., compressed), such that a portion between the liner 1 and the flange 120 may be securely sealed.

Meanwhile, the fastener 200 may include a nut 210 having an inner surface on which the screw thread 211 is formed, and an extension wall (also referred to as an extension member) 220 extending from an upper surface of the nut 210 in a height direction of the flange 120 and formed in a stepped shape so that inner and outer diameters of the extension wall 220 decrease upward. The extension wall 220 and the nut 210 may be integrated with each other.

An outer surface of the nut 210 is formed in a polygonal or toric shape (e.g., cross-section), such that the nut 210 may be rotated by a separate tool such as a spanner wrench. The nut 210 may be a member screw-coupled to the end of the flange 120. The screw thread, which is identical to (e.g., corresponds to or matches) the screw thread corresponding to the flange 120, may be formed on the inner surface of the nut 210 so that the nut 210 may be screw-coupled to the end of the flange 120.

The extension wall 220 is integrated with the nut 210. As described above, the extension wall 220 is a member extending from the upper surface of the nut 210 in the height direction of the flange 120 and formed in the stepped shape so that the inner and outer diameters of the extension wall 220 decrease upward.

Because the extension wall 220 is provided on the upper surface of the nut 210 and formed in the stepped shape so that the inner and outer diameters of the extension wall 220 decrease upward in the height direction of the flange 120, the flange 120 may be pressed at the plurality of points by the inner diameter of the stepped shape when the nut 210 is screw-fastened to the end of the flange 120.

Further, the extension wall 220 may include one or more gaskets (also referred to as a sealability maintaining means, rings, or O-rings) 230 capable of maintaining sealability (e.g., creating a seal) in the boundary region (e.g., seam) when the nut 210 is screw-fastened to the flange 120. The one or more gaskets 230 may be made of a flexible (e.g., compressible) and/or impermeable material such as rubber.

The gaskets 230 are installed on the inner and outer walls of the extension wall 220 and prevent the fluid, which is stored inside the liner 1, from leaking through a gap, which may be formed between the flange 120 having the stepped outer diameter and the extension wall 220 having the stepped outer diameter, and a gap that may be formed between the extension wall 220 and the liner 1.

The gaskets 230 may include a first O-ring 231 installed on the inner circular wall surface of the extension wall 220, and a second O-ring 232 installed on the outer circular wall surface of the extension wall 220. The first O-ring 231 may be disposed between the extension wall 220 and the flange 120, and the second O-ring 232 may be disposed between the extension wall 220 and the liner 1, thereby maintaining the sealability.

A rib (also referred to as a rib member) 1a may be provided on an inner peripheral surface of the liner 1 disposed in the boundary region (e.g., seam) so that the second O-ring 232 may be disposed between the extension wall 220 and the liner 1. The rib 1a may be configured to be in contact with the second O-ring 232 and protrude to maintain the sealability.

Further, an outer surface of the flange 120, which is in contact with the first O-ring 231, and an outer surface of the rib 1a, which is in contact with the second O-ring 232, are tapered upward so that the outer surface of the flange 120 and the outer surface of the rib 1a become closer to a lateral surface of the extension wall 220 in the height direction of the extension wall 220.

Because the outer surface of the flange 120 and the outer surface of the rib 1a are tapered, the first O-ring 231 and the second O-ring 232 may be respectively further tightly attached to the outer surface of the flange 120 and the outer surface of the rib 1a when (e.g., after) the nut 210 is fastened to the end of the flange 120 and the extension wall 220 presses (e.g., presses against) the boundary region (e.g., seam).

Further, an inner ring (also referred to as an inner pressing member) 240 and an outer ring (also referred to as an outer pressing member) 250 may be respectively installed on the inner and outer walls of the extension wall 220 and provided below the first O-ring 231 and the second O-ring 232. The inner ring and the outer ring may be made of a material more rigid (e.g., incompressible) than that of the one or more gaskets 230 (e.g., the first O-ring 231 and the second O-ring 232).

The inner ring 240 may come into contact with the first O-ring 231 and press the first O-ring 231 toward the flange 120, and the outer ring 250 may come into contact with the second O-ring 232 and press the second O-ring 232 toward the liner 1, thereby securely implementing the sealability.

The first O-ring 231 and the second O-ring 232 are respectively installed on the inner and outer surfaces of the extension wall 220, and the inner ring 240 and the outer ring 250 are respectively installed on the inner and outer surfaces of the extension wall 220. Therefore, when an internal pressure of 700 bar or higher is generated below the inner ring 240 and the outer ring 250, the inner ring 240 and the outer ring 250 respectively push (e.g., compress) the first O-ring 231 and the second O-ring 232 upward, such that secure sealability may be implemented, and a primary seal may be implemented by utilizing the internal pressure applied by the fluid stored inside the liner 1.

Further, a protrusion (also referred to as a protruding piece) 260 is formed at an upper end (e.g., tip) of the extension wall 220. The protrusion 260 protrudes in the height direction of the extension wall 220 and is inserted into the boundary region (e.g., seam). A third O-ring 270 may be installed in the boundary region into which the protrusion 260 is inserted. In other words, the third O-ring 270 may be installed (e.g., wedged) between the protrusion and the boundary region (e.g., seam).

The one or more gaskets 230 may include a first gasket (e.g., the first O-ring 231), a second gasket (e.g., the second O-ring 232), and a third gasket (e.g., the third O-ring 270). The first gasket may be wedged between the second disc and the second ring. The second gasket may be wedged between the second ring and the liner. The third gasket may be wedged between the third ring and the seam (e.g., the boundary region).

With the above-mentioned configuration, the nut 210 may be rotated and coupled to the flange 120 so that a torque value is greater than or equal to a threshold torque value (e.g., 35 Nm) when the nut 210 is fastened to the end of the flange 120. As a result, the third O-ring 270 is pressed (e.g., compressed) at a threshold pressure value (e.g., 857 bar) or greater by the protrusion 260, such that secondary seal may be implemented by the internal pressure.

The secondary seal may consistently maintain excellent sealability even if the internal pressure inside the liner 1 is lowered because of a leak of the fluid stored inside the liner 1 or the use of the fluid stored inside the liner 1.

The boss for a hydrogen tank according to the present disclosure configured as described above may implement a primary high-pressure seal by using the pressure applied by the stored fluid and implement a secondary seal by generating constant pressure in the low-pressure region that may be formed by a leak of the fluid while the pressure is released, thereby ensuring the structure of the boss with excellent sealability.

A boss for a hydrogen tank may include: a nozzle boss including a neck portion having a hollow portion and extending by a predetermined length, and a flange portion provided at one side of the neck portion, integrated with the neck portion, and configured to be joined to a liner having a charging space capable of being charged with a fluid; and a sealing part installed in an end region of the flange portion and provided to be in contact with a boundary region between the nozzle boss and the liner in order to prevent a leak of the fluid from the boundary region between the nozzle boss and the liner.

An end region of the flange portion may be formed in a stepped shape so that an outer diameter of the end region of the flange portion decreases downward, and an inner diameter portion of the sealing part, which is installed to be in contact with an outer diameter portion of the flange portion, may be formed in a stepped shape corresponding to the outer diameter of the flange portion.

A screw thread may be formed on an outer diameter portion of a lowermost portion of the flange portion, a screw thread may be formed on an inner surface of a lowermost portion of the sealing part, and the sealing part may be screw-fastened to the flange portion.

The sealing part may include: a nut member having an inner surface on which the screw thread is formed; and an extension member provided on an upper surface of the nut member, extending in a height direction of the flange portion, and formed in a stepped shape so that inner and outer diameters of the extension member decrease upward.

The extension member may include a sealability maintaining means configured to maintain sealability in the boundary region when the nut member is screw-fastened to the flange portion.

The sealability maintaining means may include: a first O-ring installed on an inner diameter portion of the extension member; and a second O-ring installed on an outer diameter portion of the extension member.

An inner pressing member and an outer pressing member may be respectively installed on the inner and outer diameter portions of the extension member and provided below the first O-ring and the second O-ring.

A rib member may protrude from an inner peripheral surface of the liner disposed in the boundary region so that the rib member comes into contact with the second O-ring to maintain sealability.

A protruding piece may be formed at an upper end of the extension member, protrude in the height direction of the extension member, and be inserted into the boundary region.

A third O-ring may be installed in the boundary region into which the protruding piece is inserted.

While the one or more example embodiments, which may be implemented by the present disclosure, have been described above, the example embodiments are just illustrative and not intended to limit the present disclosure. It can be appreciated by those skilled in the art that various modifications and applications, which are not described above, may be made to the present disclosure without departing from the intrinsic features of the present disclosure. For example, the respective constituent elements specifically described in the example embodiments may be modified and then carried out. Further, it should be interpreted that the differences related to the modifications and applications are included in the scope of the present disclosure defined by the appended claims.

What is claimed is:

1. A boss for a hydrogen tank, the boss comprising:
a nozzle boss comprising:
a neck extending by a predetermined length, wherein a chamber is formed inside the neck; and
a flange provided at a bottom portion of the neck, wherein the flange is integrated with the neck and configured to be joined to a liner of the hydrogen tank; and
a fastener installed at a lower region of the flange and in contact with a seam between the nozzle boss and the liner, to prevent a leak of a fluid through the seam.

2. The boss of claim 1, wherein the flange, at the lower region, tapers off with a first cascading contour, wherein an inner surface of the fastener is installed to be in contact with an outer surface of the flange, and wherein the inner surface of the fastener has a second cascading contour that matches the first cascading contour of the flange.

3. The boss of claim 2, wherein a first screw thread is formed on a surface of a lowermost step of the first cascading contour of the flange, wherein a second screw thread is formed on a surface of a lowermost step of the second cascading contour of the fastener, and wherein the fastener is screw-fastened to the flange via the first screw thread and the second screw thread.

4. The boss of claim 3, wherein the fastener comprises:
a nut corresponding to the lowermost step of the second cascading contour of the fastener, wherein the nut has the surface on which the second screw thread is formed; and
an extension wall disposed on top of the nut and tapering off with the second cascading contour.

5. The boss of claim 4, wherein one or more gaskets are provided on the extension wall to maintain a seal at the seam after the nut is screw-fastened to the flange.

6. The boss of claim 5, wherein the one or more gaskets comprise:
a first O-ring installed on an inner surface of the extension wall; and
a second O-ring installed on an outer surface of the extension wall.

7. The boss of claim 6, wherein an inner ring is installed, below the first O-ring, on the inner surface of the extension wall, and wherein an outer ring is installed, below the second O-ring, on the outer surface of the extension wall.

8. The boss of claim 6, wherein the liner comprises a rib that extends from an inner peripheral surface of the liner to the seam, wherein the rib comes into contact with the second O-ring to maintain the seal at the seam.

9. The boss of claim 6, wherein a protrusion is formed at an upper tip of the extension wall and is inserted into the seam.

10. The boss of claim 9, wherein the one or more gaskets further comprise a third O-ring installed between the protrusion and the seam.

11. A boss assembly comprising:
a boss comprising:
a nozzle having a cylindrical shape, wherein the nozzle comprises a gas inlet to a gas storage tank;
a flange radially extending out from a bottom portion of the nozzle to be joined, at a seam, to a liner of the gas storage tank;
a first disc disposed below the flange, the first disc having a first diameter;
a second disc disposed below the first disc, the second disc having a second diameter that is less than the first diameter; and
a third disc disposed below the second disc, the third disc having a third diameter that is less than the second diameter, wherein a first screw thread is formed on an outer surface of the third disc;
a fastener configured to be fastened against the boss and the liner to create a seal at the seam, wherein the fastener comprises:
a first ring having a first radial thickness, wherein a second screw thread, which corresponds to the first screw thread, is formed on an inner surface of the first ring;
a second ring having a second radial thickness that is less than the first radial thickness, wherein the second ring is disposed on top of the first ring; and
a third ring having a third radial thickness that is less than the second radial thickness, wherein the third ring is disposed on top of the second ring; and
a plurality of gaskets comprising:
a first gasket wedged between the second disc and the second ring;
a second gasket wedged between the second ring and the liner; and
a third gasket wedged between the third ring and the seam,
wherein the nozzle, the flange, the first disc, the second disc, and the third disc of the boss are integrated to each other, and
wherein the first ring, the second ring, and the third ring of the fastener are integrated to each other.
